(19) United States
(12) Patent Application Publication
(10) Pub. No.: US 2007/0139543 A1
(43) Pub. Date: Jun. 21, 2007

(54) Auto-adaptive frame rate for improved light sensitivity in a video system

(75) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation, Horsham, PA (US)

(21) Appl. No.: 11/303,267

(22) Filed: Dec. 16, 2005

(51) Int. Cl. H04N 5/335; H04N 3/14; G06F 1/00

(52) U.S. Cl. 348/296; 348/302; 713/501

(57) ABSTRACT

A system, method and computer readable medium are described that improve the performance of video systems. Light is shown-upon an image pickup device such as a CCD. Frames are generated in response to a clock signal that is proportional to a frame rate. In low-light conditions the frame rate and clock signal are reduced in frequency by a clock circuit so that more light is shown upon the image pickup device per frame. The clock circuit responds to a control signal from a processor that compares a representation of the image data with threshold data to determine the level of light.

### BACKGROUND

Video systems capture light reflected off of desired people and objects and convert those light signals into electrical signals that can then be stored or transmitted. All of the light signals reflected off of an object in one general direction comprise an image, or an optical counterpart, of that object per unit time. Video systems capture numerous images per second. This allows for the video display system to project multiple images per second back to the user so the user observes continuous motion. While each individual image is only a snapshot of the person or object being displayed, the video display system displays more images than the human eye and brain can process every second. In this way the gaps between the individual images are never perceived by the user. Instead the user perceives continuous movement.

In many video systems, images are captured using an image pick-up device such as a charged-coupled device (CCD) or a CMOS image sensor. This device is sensitive to light and accumulates an electrical charge when light is shone upon it. The more light shone upon an image pick-up device, the more charges it accumulates.

In general, there are at least four factors that determine how many photons, which translate to a number of electrons, will be collected. One factor is the area or size of the individual sensors in the image pick-up device. The larger the individual sensors, the more photons they collect. Another factor is the density of the photons collected by the lens system that are focused onto the image pick-up device. A poor quality lens system will have a lower density of photons. In addition, the efficiency of the individual sensors and their ability to capture photons and convert those captured photons into electrons. Again, a poor quality sensor will generate fewer electrons for the photons that strike it. Finally, the amount of time an image is shone upon the image pick-up device will also influence how many photons are captured and generate electrons. The first three factors are generally dictated by process technologies and cost.

The intensity of light over a given area is called luminance. The greater the luminance, the brighter the light and the more electrons will be captured by the image pick-up device for a given time period. Any image captured by an image pick-up device under low-light conditions will result in fewer electrons or charges being accumulated than under high-light conditions. These images will have lower luminance values.

Similarly, the longer light is shone upon a CCD or other image pick-up device the more electrical charge it accumulates until saturation. Thus, an image that is captured for a very short amount of time will result in fewer electrons or charges being accumulated than if the CCD or other image pick-up device is allowed to capture the image for a longer period of time.

Low-light conditions can be especially problematic in video telephony systems. Especially for capturing the light reflected from people's eyes. The eyes are shaded by the brow causing less light to reflect off of the eyes and into the video telephone. This in turn causes the eyes to become dark and distorted when the image is reconstituted for the other user. This problem is magnified when the image data pertaining to the person's eyes is compressed so that fine details, already difficult to obtain in low-light conditions, are lost. This causes the displayed eyes to be darker and more distorted. In addition, as the light diminishes, the noise in the image becomes more noticeable. This is because most video systems have an automatic gain control (AGC) that adjusts for low-light conditions. As the light decreases, the gain is increased. Unfortunately, the gain not only increases the image data, but it also increases the noise. To put it another way, the signal to noise ratio (SNR) decreases as the light decreases.

As noted earlier, video imaging requires multiple images per second to trick the eye and brain. It is therefore necessary to capture many images from the CCD array every second. That is, the charges captured by the CCD must be moved to a processor for storage or transmission quickly to allow for a new image to be captured. This process must happen several times every second.

A CCD contains thousands or millions of individual cells. Each cell collects light for a single point or pixel and converts that light into an electrical signal. A pixel is the smallest amount of light that can be captured or displayed by a video system. To capture a two-dimensional light image, the CCD cells are arranged in a two dimensional array.

A two-dimensional video image is called a frame. A frame may contain hundreds of thousands of pixels arranged in rows and columns to form the two-dimensional image. In some video systems this frame changes 30 times every second (i.e., a frame rate of 30/sec). Thus, the image pick-up device captures 30 images per second.

0] In understanding how a frame is collected, it is useful to first describe how a frame is displayed. In traditional cathode ray tube displays, a stream of electrons is fired at a phosphorous screen. The phosphorous lights-up upon being struck by the electrons and displays the image. This single beam of electrons is swept or scanned back and forth (horizontal) and up and down (vertical) across the phosphorous screen. The electron beam begins at the upper left corner of the screen and ends at the bottom right corner. A full frame is displayed, in non-interleaved video, when the electron beam reaches the bottom right corner of the display device.

For horizontal scanning, the electron beam begins at the left of the screen, is turned on and moved from left to right across the screen to light up a single row of pixels. Once the beam reaches the right side of the screen, the electron beam is turned off so that the electron beam can be reset at the left edge of the screen and down one row of pixels. This time that the electron beam is turned off between scanning rows of pixels is called the horizontal blanking interval.

Similarly, once the electron beam reaches the bottom, it is turned off so that it can be reset at the top edge of the screen. This time the electron beam is turned off between frames as the electron beam is reset is called the vertical blanking interval.

In image capture systems, the vertical synchronization signal generally is synchronized with when an image is captured and the horizontal synchronization signal is generally synchronized with when the image data is output from the image pick-up device.

There is a perceived quality trade-off between the frame rate and image distortion. Higher frame rates give a more natural sense of motion but this benefit can be reduced if the images displayed are overly distorted.

### BRIEF DESCRIPTION OF THE DRAWINGS

FIG. 1 is an example of a charge-coupled device (CCD);

FIG. 2 is a timing diagram for operation of the CCD shown in FIG. 1;

FIG. 3 is an example of a CMOS image sensor;

FIG. 4 is a timing diagram for operation of the CMOS image sensor shown in FIG. 2;

FIG. 5 is an example of a video system;

FIG. 6 is a flow chart for a process of capturing images;

FIG. 7 is an example of samples of pixels from an image; and

FIG. 8 is another example of a video system.

### DETAILED DESCRIPTION

As noted earlier, low-light conditions make it difficult to capture high quality images in video telephones, camera phones and other video processing systems. A system and method are described which compensate for variable light conditions by controlling the rate of select operations of the video processing device.

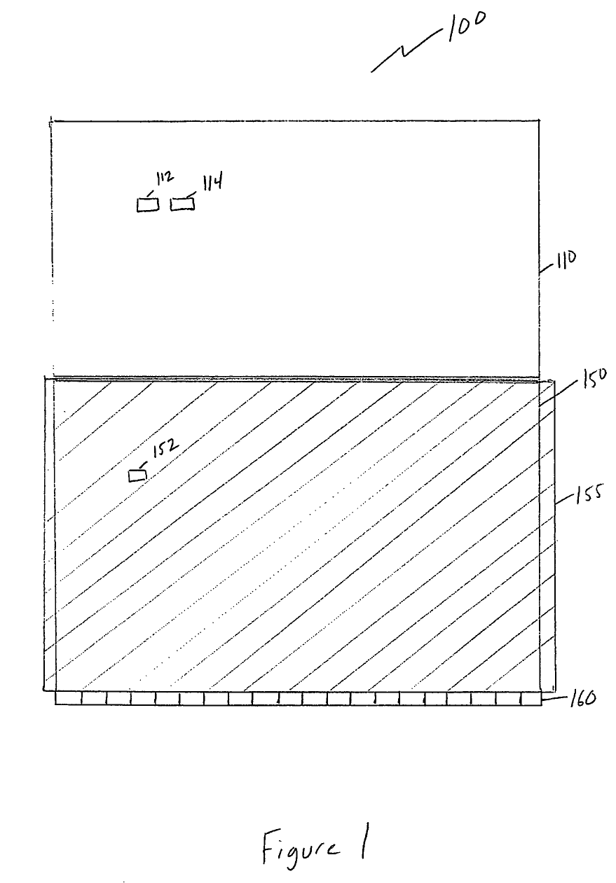

FIG. 1 is a diagram of an exemplary image pick-up device called a charge-coupled device (CCD) 100. CCD 100 is comprised of two arrays 110 and 150. Each CCD array has numerous CCD elements 112 and 152 arranged in rows and columns. Array 110 is the imaging array and array 150 is the readout array. Arrays 1 10 and 150 are the same size. As an example, arrays 110 and 150 may each comprise 640 CCD elements 112 and 152 in each row and 480 CCD elements 112 and 152 in each column. The total number of pixels for a frame is calculated by multiplying these numbers (640×480=307,200 pixels per frame).

Arrays 110 and 150 differ structurally. For example, each CCD element 112 in array 110 has a storage element 114 adjacent to and coupled to it. These storage elements 114 receive the charge generated by each CCD element 112 in conjunction with capturing an image. Array 150 is covered by an opaque film 155. Opaque film 155 prevents the CCD elements 152 from receiving light whereas elements 112 in array 110 receive light reflected from the object or person and convert that light into electrical signals.

The operation of CCD 100 is as follows. Light is received by array 100 so as to capture an image of the desired person or object. The electrical charges stored in each CCD element 112 are then transferred to a respective storage element 114. The stored charges are then transferred serially down through array 110 into array 150. After array 150 has all the electrical charges associated with the captured image from array 110 these charges are then transferred to register 160. Register 160 then shifts each charge out of CCD 100 for further processing.

All of the above mentioned transfers (from CCD element 112 to storage element 114, through array 110 to array 150, through array 150 through to register 160 and finally shifting through register 160) occur under the control of various clock signals. In this example, CCD device 100 receives four clock signals or generates them itself with an on-chip clock circuit that receives a reference clock signal.

The first clock signal transfers the charges from CCD elements 112 to storage element 114. The second clock signal transfers all of the charges stored in storage elements 114 down into elements 152 in array 150. The third clock signal transfers the charges stored in elements 152 to register 160. The fourth clock transfers the charges from register 160 out of CCD device 100. All of these clock signals are synchronized together and with the horizontal and vertical blanking periods as will be described later.

In one example, the clocks that control transfer of charges from the CCD elements 112 to storage elements 114 and the clock that controls the transfer of charges through array 110 to array 150 are synchronized with the vertical blanking period. The clock that controls transfer of charges through array 150 to register 160 is synchronized with the horizontal blanking interval. The clock that controls the transfer of charges from register 160 out of CCD 100 is synchronized with the active line (i.e., the time when a video display device is projecting electrons onto the phosphorous screen and when a video capture device is capturing an image).

To control both image capture and display, vertical and horizontal synchronization signals are generated. In video display systems, the vertical synchronization signal controls the vertical scanning of the electron beam up and down the screen. In performing this scanning, the vertical synchronization signal has two parts. The first part is the active part where the electron beam is on and generating pixels on the display device. The second part is where the electron beam is turned off so as to return to the top-left corner of the screen. The part is called the vertical blanking interval.

Similarly, the horizontal synchronization signal controls the horizontal scanning of the electron beam left and right across the screen. This signal also has two parts. The first part is the active part where the electron beam is on and generating pixels on the display device. The second part is where the electron beam is turned off so as to return to the left edge of the screen. This part is called the horizontal blanking interval.

The length of time of the vertical blanking interval is directly related to the desired frames per second. An exemplary 30 frames per second system either captures or displays a full frame every 33.33 msec. The National Television Systems Committee (NTSC) standard requires that 8% of that time be allocated for the vertical blanking interval. Using this standard as an example, a 30 frames per second system has a vertical blanking interval of 2.66 msec and an active time of 30.66 msec to capture a single frame or image. For a 24 frames per second system, the times are 3.33 msec and 38.33 msec, respectively. Thus, a slower frame rate gives the CCD device more time to capture an image. This improves not only the overall luminance of the captured image, but also the dynamic range (i.e., the difference between the lighter and darker portions of the image).

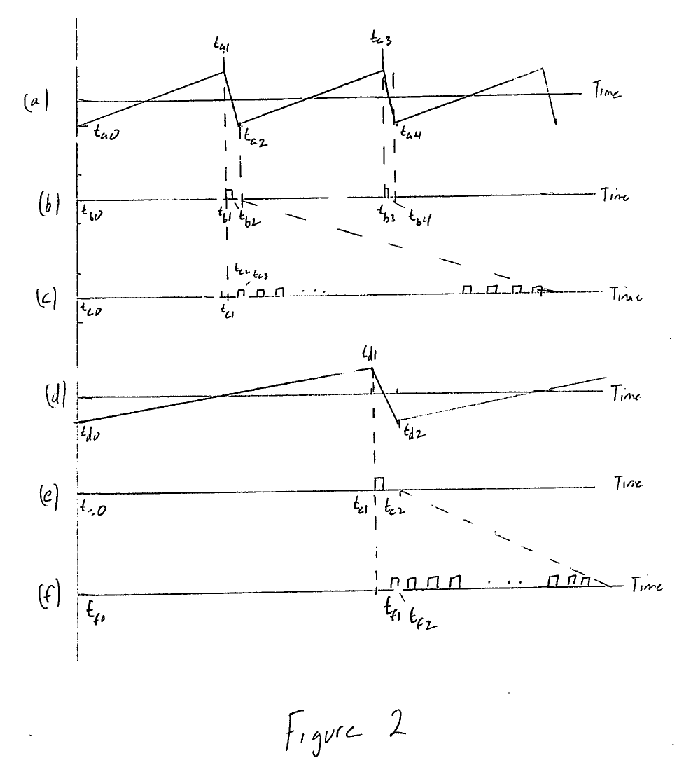

The relationships between two of those clock signals and the vertical blanking interval are shown in FIG. 2. The other two clock signals and their relationships to the horizontal blanking interval are not shown. Time lines (a), (b) and (c) in FIG. 2 show the relationship for one frame rate while time lines (d), (e) and (f) show the same relationship for a second frame rate. Time line (a) shows the vertical synchronization signal for one frame rate. From time tₐ₀ to time tₐ₁ the video system is active. In other words, it is collecting light to form the image. From time tₐ₁ to tₐ₂ the video system is inactive. During this time period the video capture system has completed capturing an image. This time period is the vertical blanking period. As shown in FIG. 2, this signal repeats such that a single frame is captured and processed during each cycle. The frequency of the vertical synchronization signal in (a) is the reciprocal of the time between tₐ₀ and tₐ₂.

As stated earlier, CCD device 100 captures the image in array 110 during the active portion of the vertical synchronization signal. After the image is captured in elements 112 of array 110, it is transferred to storage elements 114. This first clock signal, shown in (b) of FIG. 2, controls this transfer. The first clock signal is periodic with a frequency proportional to the vertical synchronization signal. In the examples shown in time lines (a) and (b) that proportion is 1:1.

The charge collected in elements 112 is transferred to storage elements 114 with the pulse shown between time t_{b1} and t_{b2}. The pulse is not transmitted until the beginning of the vertical blanking period at time tₐ₁. After this pulse is used by the CCD device 100, the elements 112 are empty while the storage devices 114 contain the charges previously accumulated by elements 112.

The next operation is to transfer the charges from storage elements 114 to elements 152 in array 150. The clock signals that perform this function are shown in (c). The scale for (c) with respect to the scales for (a) and (b) has been expanded for clarification. After time t_{b2}, the second clock signal begins at t_{c1}. This clock pulses once for every row of elements 112 in array 110. All of these pulses must be transmitted between t_{b2} and tₐ₂.

Time lines (d)-(f) show the same process but for a different frame rate. Like time line (a), an image is captured between times t_{d0} and t_{d1} in time line (d). After the image is captured, the first clock signal pulses between times tₑ₁ and tₑ₂ in time line (e). This pulse transfers the charges from elements 112 to storage element 114. After storage elements 114 receive the charges from elements 112, they are then transferred down to array 150 under the control of the second clock signal shown in timeline (f). Again, timeline (f) is shown in expanded scale with respect to timelines (d) and (e). These pulses do not begin until after time tₑ₂ and end before time t_{d2}.

A slower vertical synchronization signal (i.e., lower frequency) correlates to a lower frame rate. This means a slower vertical synchronization signal has a longer period which in turn means a longer time to capture an image. This is shown in FIG. 2 where the time between t_{d0} and t_{d1} is longer than the time between tₐ₀ and tₐ₁. As a consequence tₑ₁ is later in time than t_{b1}. This in turn gives array 110 in CCD device 100 a longer time to capture the light to form the image before the pulse signal from the first clock signal is transmitted. In low-light conditions, this longer time means more charges can be captured per frame resulting in better signal level and dynamic range of the image.

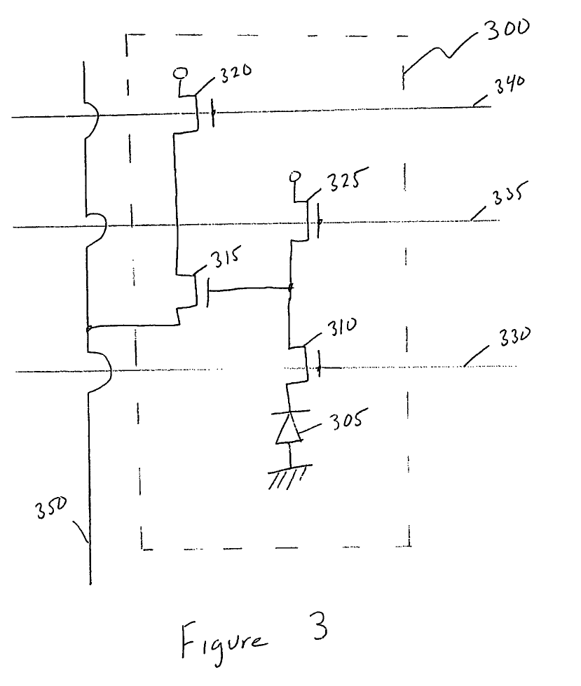

FIG. 3 is a diagram of a CMOS image sensor. Like the CCD device shown in FIG. 1, a CMOS image sensor contains thousands of individual cells. One such cell 300 is shown in FIG. 3. Cell 300 contains a photodiode (or some other photo-sensitive device) that generates an electrical signal when light is shown upon it. The electrical signal generated by photodiode 305 is read by turning on read transistor 310. When read transistor 310 is turned-on, the electrical signal generated by photodiode 305 is transferred to amplifying transistor 315. Amplifying transistor 315 boosts the electrical signal received via read transistor 310. Address transistor 320 is also turned on when data is being read out of cell 300. After the data has been read and amplified, the cell 300 is reset by reset transistor 325. In some implementations of a CMOS image sensor, a shift register, like shift register 160 of FIG. 1, is coupled to output lines 350.

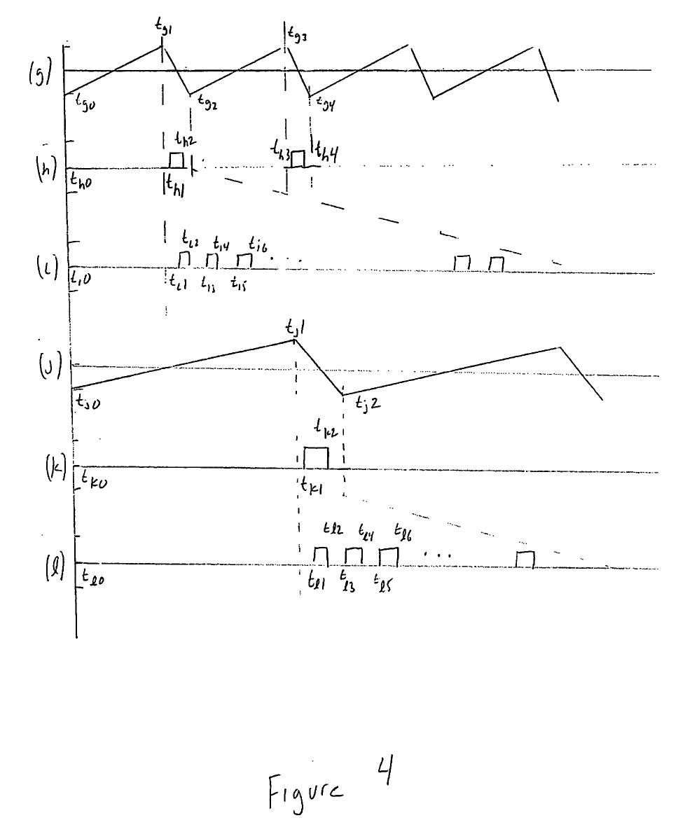

The timing and operation of cell 300 will be described in conjunction with the timing diagrams shown in FIG. 4. Time lines (g), (h) and (i) in FIG. 4 show the relationship for one frame rate while timelines (j), (k) and (1) show the same relationship for a second frame rate. Time line (g) shows the vertical synchronization signal for one frame rate. From time t_{g0} to t_{g1} the video system is active and collecting light to form the image. From time t_{g1} to t_{g2} the video system is inactive. This time period is the vertical blanking period previously described at which point the video capture system has completed capturing an image. The frequency of the vertical synchronization signal in (g) is the reciprocal of the time between t_{g0} and t_{g2}.

The charges collected by photodiodes 305 are transferred to amplifying transistors 315 when the read line 330 is asserted via the pulse shown in time line (h) between times tₕ₁ and tₕ₂. This pulse is not transmitted until the beginning of the vertical blanking period at time tg1. Once the read transistors 310 have been turned on by the pulse applied on line 330, the amplifying transistors are “ready” to amplify the electrical signals.

Many cells 300 share output line 350. Each cell 300 outputs its signal onto line 350 when the associated address line 340 is asserted. The plurality of address pulses are shown in time line (i). The scale for time line (i) has been expanded to show the plurality of pulses that occur during a read pulse asserted on line 330. After all of the cells 300 have outputted their data onto line 350, the array of cells is reset by asserting a pulse on lines 325.

Time lines (j)-(k) show the same process but for a different frame rate. Like time line (g), an image is captured between times tj0 and tj1. After the image is captured, the first clock signal pulses between times tk1 and tk2 in time line (k). This pulse turns on the respective read transistors 310. While read transistor 310 is on, the various address transistors are turned on in succession using the pulses shown in time line (l) (one pulse for each row of cells 300). Again, the scale for time line (l) is expanded relative to time lines (j) and (k).

Like the CCD example described in conjunction with FIGS. 1 and 2, a slower vertical synchronization signal (i.e., lower frequency) correlates to a lower frame rate. This means a slower vertical synchronization signal has a longer period, which in turn means a longer time to capture an image. This is shown in FIG. 4 where the time between tg0 and tg1 is shorter than the time between tj0 and tj1. As a consequence the read pulse between tk1 and tk2 occurs later in time than the read pulse between th1 and th2. This in turn gives the CMOS image sensor more time to capture the light to form the image.

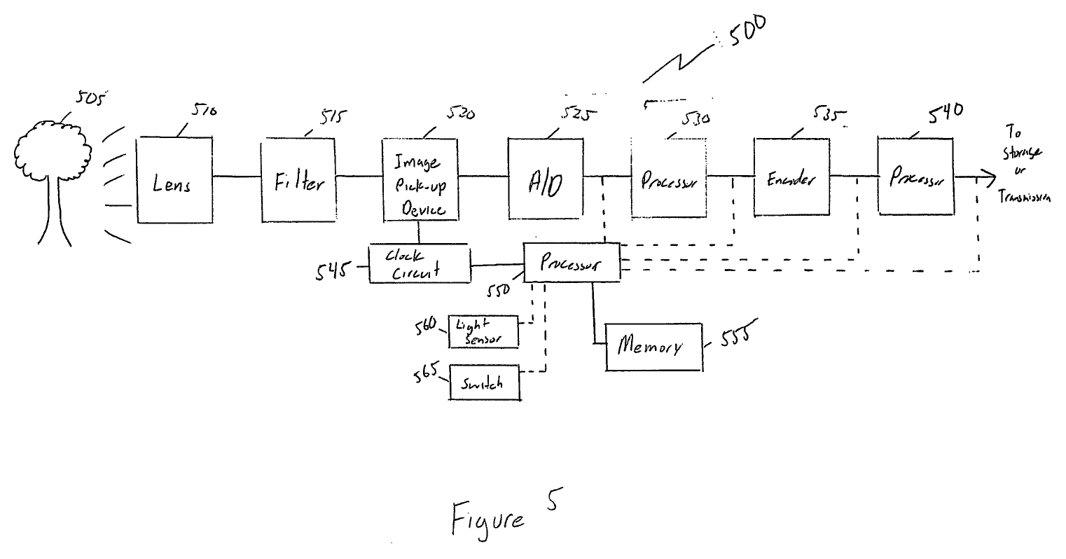

FIG. 5 is a diagram of an exemplary video camera system 500. An image of object 505 is to be captured. Lens 510 focuses the light reflecting from object 505 through one or more filters 515. Filters 515 remove unwanted characteristics of the light. Alternatively, multiple filters 515 may be used in color imaging. The filtered light is then shown upon image pick-up device 520. In one exemplary image pick-up device the light is shown upon array 110 of CCD 100 or CMOS image sensor as previously described. The charges associated with each individual pixel are then sent to analog-to-digital (A/D) converter 525. A/D converter 525 generates digitized pixel data from the analog pixel data received from image pick-up device 520. The digitized pixel data is then forwarded to processor 530. Processor 530 performs operations such as white balancing, color correction or may break the data into luminance and chrominance data. The output of processor 530 is enhanced digital pixel data. The enhanced digital pixel data is then encoded in encoder 535. As an example, encoder 535 may perform a discrete cosine transform (DCT) on the enhanced digital pixel data to produce luminance and chrominance coefficients. These coefficients are forwarded to processor 540. Processor 540 may perform such functions as normalization and/or compression of the received data. The output of processor 540 is then forwarded to either a recording system that records the data on a medium such as an optical disc, RAM or ROM or to a transmission system for broadcast, multicast or unicast over a network such as a cable, telephone or satellite network (not shown).

As noted earlier, image pick-up device 520 outputs its analog pixel data in response to various clock signals. These clock signals are provided by clock circuit 545. Clock circuit 545 varies the frequencies of one or more clock signals in response from a control signal issued by processor 550. Clock circuit 545 may generate its own reference clock signal (for example via a ring oscillator) or it may receive a reference clock from another source and generate the required clock signals using a phase-locked loop (PLL) or it may contain a combination of both a clock generation circuit (e.g., ring oscillator) and clock manipulation circuit (e.g., PLL). Processor 550 receives data from memory 555. Memory 555 stores basis data. This basis data is used in conjunction with another signal or signals generated by the video system 500 to determine if the frame rate and associated clock signals need adjustment. In one exemplary system, the basis data is threshold data that is compared with another signal or signals generated by the video system 500.

Processor 550 receives one or more inputs from sources in video system 500. These sources include the output of A/D converter 525, processor 530, encoder 535 and processor 540. These exemplary inputs to processor 550 are shown in FIG. 5 as dashed lines because any one or more of these connections may be made depending on the choices made by a manufacturer in designing and building a video system. These signals may also form part of the automatic control of the video system 500. In these systems, processor 550 outputs control signals (not shown) to image pick-up device 520, A/D converter 525, processor 530, encoder 535 and/or processor 540. These output control signals from processor 550 may be part of an automatic gain control (AGC), automatic luminance control (ALC) or auto-shutter control (ASC) sub-system.

As described earlier, A/D converter 525 converts the analog pixel data received from image pick-up device 520 to digitized pixel data. The output of A/D converter 525 may be, for example, one eight-bit word for each pixel. Processor 550 can compare the magnitude of these eight-bit words to threshold data from memory 555 to determine the brightness of the images being captured. If the images are not bright enough, the eight-bit words will have small values and processor 550 will issue a control signal to clock circuit 545 instructing it to decrease the frequency of the frame rate and a first clock signal (see time lines (b) and (e) in FIG. 2 and time lines (h) and (k) in FIG. 4). Similarly, if the images are too bright, the eight bit words will have large values and processor 550 will issue a different control signal to clock circuit 545 instructing it to increase the frequency of the first clock signal.

Processor 530 may derive the brightness (luminance) and color (chrominance) values from the words received from A/D converter 525. The luminance values generated by processor 530 may be transmitted to processor 550 where they are compared to threshold data received from memory 555.

Encoder 535 generates a signal in the frequency domain from the data received from processor 530. More specifically, encoder 535 generates transform coefficients for both the luminance and chrominance values received from processor 530. Processor 550 may receive the luminance coefficients and compare those values to the threshold data received from memory 555.

Processor 540 may normalize and compress the signals received from encoder 535. This normalized and compressed data may be transmitted to processor 550 where it is denormalized and decompressed. The subsequent data is then compared against the threshold data stored in memory 555.

Processor 550 may also receive signals from light sensor 560. Light sensor 560 measures the ambient light in the area and sends a data signal representative of that measurement to processor 550. Processor 550 compares this signal against threshold data received from memory 555 and adjusts the clock via clock control circuit 545 accordingly. If the ambient light is low, processor 550 will determine this from its comparison using threshold data from memory 555 and issue a control signal to clock circuit 545 instructing it to reduce the frame rate.

Processor 550 may also receive a signal from manual brightness control switch 565. Manual switch 565 is mounted on the external housing (not shown) of video system 500. The user of video system 500 may then adjust manual switch 565 to change the frame rate and frequency of the first clock signal of video system 500. In one exemplary system, the turning of manual switch 565 causes processor 550 to retrieve different threshold data from memory 555. Thus the results of the comparison performed by processor 550 using data from A/D converter 525, processor 530, encoder 535 or processor 540 change by using different threshold data from memory 555.

In one example, manual switch 565 is a dial connected to a potentiometer or rheostat by which the resistance is changed when the dial is turned. The change in resistance is then correlated to a change in the frame rate. It should be understood that both light sensor 560 and manual switch 565 either include integrated A/D converters or A/D converters must be inserted between light sensor 560 and processor 550 and manual switch 565 and processor 550. Alternatively, processor 550 may also include integrated A/D converters for the signals received from light sensor 560 and manual switch 565.

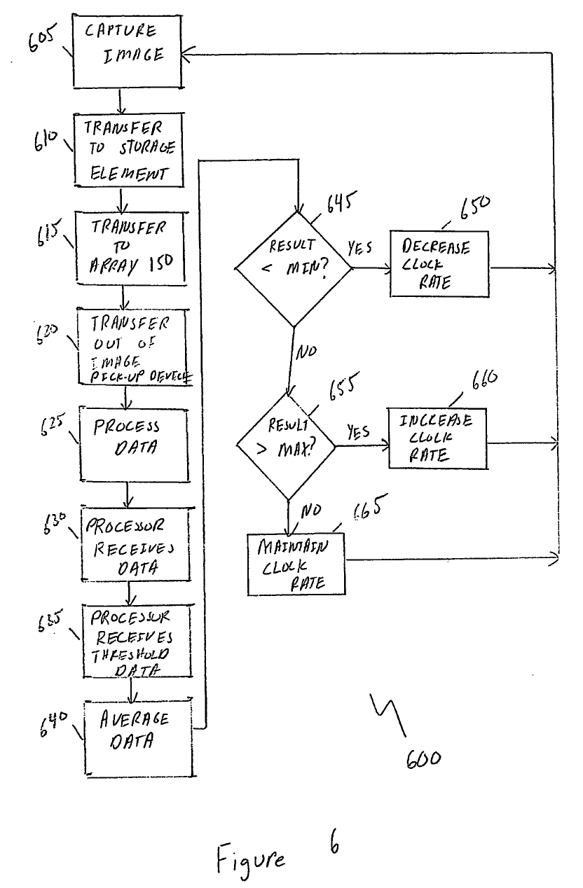

FIG. 6 is a flow chart 600 showing the operation of a video system such as the one shown in FIG. 5. At step 605 an image is captured in an image pick-up device such as CCD 100. At 30 frames per second, array 110 of CCD 100 or cell 300 of a CMOS image sensor will receive light for 30.66 msec. At step 610 the charges accumulated in elements 112 are transferred to storage elements 114. Referring to FIG. 2, this is shown in timelines (b) and (e). For the cell 300 shown in FIG. 3, step 610 correlates to turning on read transistor 310. This may occur during a portion of the vertical blanking interval. At step 615 the charges in storage elements 114 are transferred to storage array 150 of CCD 100. For cell 300, step 615 correlates to pulsing the address lines 340 so as to turn on and off address transistors 320 and thereby provide the electrical signal onto output lines 350. This also may occur during the vertical blanking interval as shown in timelines (c) and (f) of FIG. 2. At step 620, the charges stored in array 150 are transferred out of CCD 100 or CMOS image sensor via register 160. This occurs during the horizontal blanking interval.

At step 625 the image data captured by image pick-up device 520 is processed to form representative data of the image. Depending on the construction of the video system, this processing could use any combination of A/D converter 525, processor 530, encoder 535 and processor 540.

At step 630, processor 550 receives representative data of the image data captured by image pick-up device 520. In FIG. 5, this representative data may come from A/D converter 525, processor 530, encoder 535 or processor 540. Processor 550 may receive this representative data from one or more of these devices. In addition, processor 550 may also receive data from light sensor 560 and/or manual switch 565. At step 635, processor 550 retrieves threshold data from memory 555.

At step 640, processor 550 averages the representative data from a single frame. This averaging compensates for intentional light or dark spots in the image. An example of this is if the image being captured is of a person wearing a black shirt. The pixels associated with the black shirt will have low luminance values associated with it. However the existence of several low luminance values is not an indication of a low-light condition requiring a change in the frame rate in this example. By averaging many pixel luminance values, or equivalent data, across the entire frame, or across multiple frames, intended dark spots can be compensated for by lighter spots such as a white wall directly behind the person being imaged. Similarly, the existence of several high luminance values, or their equivalents, of an image of a person wearing a white shirt would not indicate a high-light condition requiring a change in the frame rate.

After the processor 550 has determined a composite luminance value for the frame, it compares that value to a minimum threshold data retrieved from memory 555 at step 545. If the composite luminance value is below a minimum threshold value, processor 550 issues a control signal at step 650 instructing clock circuit 545 to slow down certain clock signals it generates. In this example, clock circuit 545 slows down the frame rate from time line (a) to time line (d) (or time line (g) to (j)) and slows down the frequencies of the first clock signal from timeline (b) to (e) (or time line (h) to (k)) in FIGS. 2 and 4, respectively. The process then proceeds to capture another image at step 605.

If at step 645 the composite luminance values are above or equal to the minimum threshold data, processor 550 compares the composite luminance values to a maximum threshold data at step 655. If the composite luminance value is above this maximum threshold value, processor 550 issues a control signal at step 660 instructing clock circuit 545 to speed-up certain clock signals(e.g., the vertical synchronization signal and the first clock signal) it generates. If the composite luminance values are equal to or between the minimum and maximum threshold values, the clock signals generated by clock circuit 545 are maintained at their current rates at step 665. The process then continues at step 605 where the next image is captured.

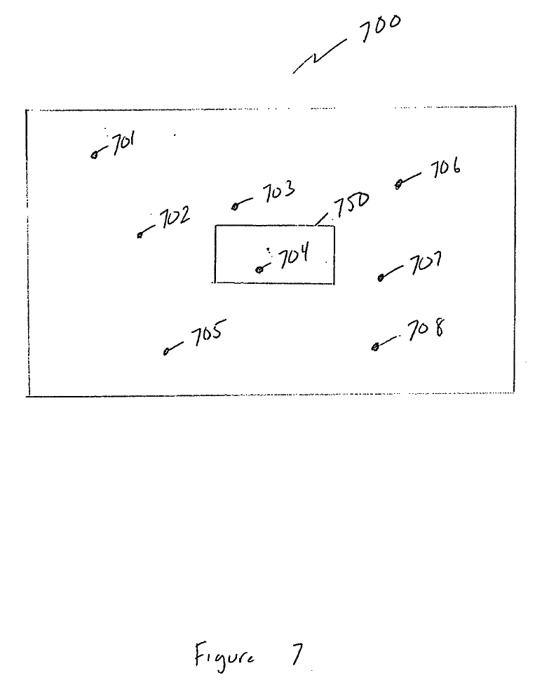

FIG. 7 shows a frame 700. From frame 700, two subsets of pixel data are shown. In the example shown in FIG. 7, a subset of pixel data is selected at random from across the entire frame 701-708. The luminance values of these pixels 701-708 are averaged by processor 550 in step 640 of FIG. 6. It should be noted that other exemplary systems may use a different number of pixel data such as 16, 32, 64 etc. As described previously, this averaging compensates for desired differences in the frame such as black shirts and white walls.

The second subset is shown as rectangle 750 in frame 700. Every luminance value for every pixel within rectangle 750 is averaged in step 640 in FIG. 6. It should be noted that other exemplary systems may use different shapes (e.g., circle, square, triangle, etc) and may use two or more subsets of pixel data defined by shapes. In addition, the shapes used to define the subset do not necessarily have to be centered in the frame as shown in FIG. 7.

In yet a third exemplary system, the video system may use all of the luminance values from all of the pixels in the frame to generate the average calculated in step 640 of FIG. 6.

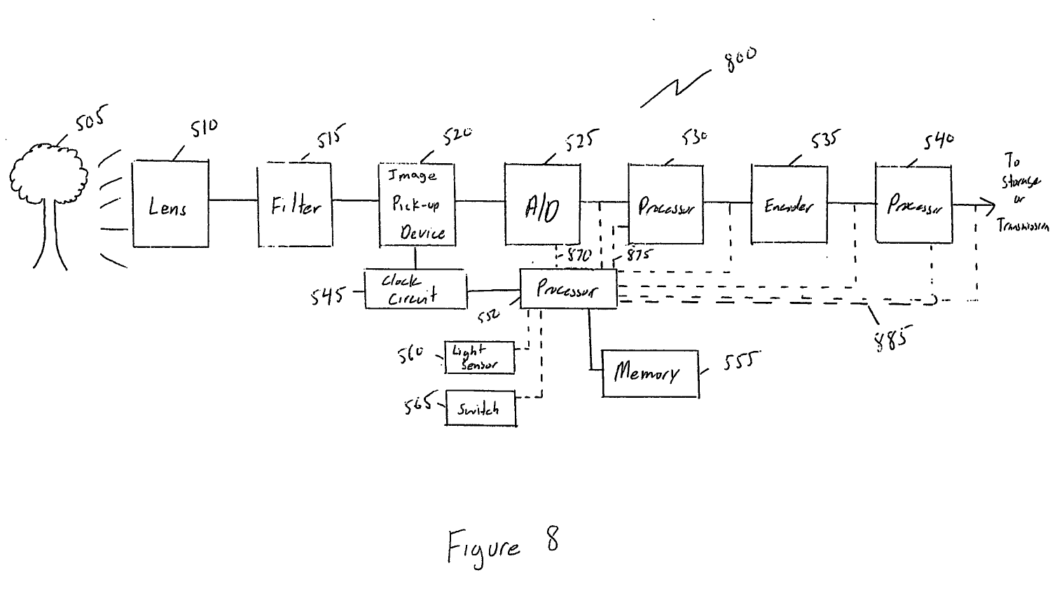

FIG. 8 shows another video capture system 800. This system is similar to video system 500 shown in FIG. 5 so a detailed explanation of every element in FIG. 8 will not be provided. Also, reference numbers used in FIG. 8 designate similar structures in FIG. 5. Video system 800 differs from video system 500 in that video system 800 has optional control signals 870 and 875 output from processor 850 to A/D converter 525 and processor 535. These are gain adjustment signals. These gain signals may be necessary if processor 550 instructs clock circuit 545 to reduce the frame rate and corresponding clock signals to a point where other aspects of the image quality are jeopardized. For example, if the frame rate is too low, the person viewing the images will notice the gaps or vertical blanking intervals between the frames. When this happens, the viewer notices a flicker in the images. When this occurs, processor 550 issues control signals 870 and 875 to increase the gain in either A/D converter 525 or processor 530 in conjunction with an increase in the frame rate. Increasing the gain in either of these devices will assist video system 800 in compensating for low-light conditions at higher frame rates.

Video system 800 also shows another control signal 880. Control signal 880 is output from processor 550 to processor 540. Control signal 880 is used to compensate for the automatic changes made in the frame rate so that the playback by another video processing system or receiver is correct.

In one implementation, control signal 880 instructs processor 540 to copy existing frames until a desired frame rate is reached. As an example, assume video system 800 begins capturing frames at 30 frames/sec. Sometime later, the ambient light is reduced and video system 800 compensates by reducing the frame rate to a select frame rate of 24 frames/sec. Control signal 880 instructs processor 540 to make copies of actual captured frames. In one example, control signal 880 instructs processor 540 to duplicate every fourth frame as the next frame in the series so that the number of frames output by processor 540 is 30 per second even though the rate at which processor 540 receives frame data from encoder 535 is 24 frames per second. In a 30 frame run, processor 540 creates the 5^{th}, 10^{th}, 15^{th}, 20^{th}, 25^{th} and 30^{th} frames by copying the 4^{th}, 8^{th} , 12^{th}, 16^{th}, 20^{th} and 24^{th} captured frames, respectively. In this way video system 800 always outputs 30 frames/sec and the receiver or playback device can be designed to expect 30 frames/sec.

Alternatively, control signal 880 may instruct processor 540 to interpolate new frames from captured frames. Using the select frame rate of 24 frames per second and 30 frames per second example above, processor 540 interpolates the 5^{th}, 10^{th}, 15^{th}, 20^{th}, 25^{th} and 30^{th} frames from the following captured frame pairs, respectively: 4^{th} and 5^{th}, 8^{th} and 9^{th}, 12^{th} and 13^{th}, 16^{th} and 17^{th}, 20^{th} and 21^{st} and 24^{th} and 1^{st} (from the next group), respectively. Again, the receiver or playback video system can then be designed to expect to receive 30 frames/sec.

In yet another alternative system, control signal 880 instructs processor 540 to put a control word in the data so that the receiver or playback device can either copy frames or interpolate frames as previously described. In this example, the video display system continually reads these control words as the frames are displayed to the user. If the control word changes, the video display device compensates accordingly by creating additional frames as previously described.

The above systems and methods may have different structures and processes. For example, processors 530, 540 and 550 may be general purpose processors. These general purpose processors may then perform specific functions by following specific instructions downloaded into these processors. Alternatively, these processors may be specific processors in which the instructions are either hardwired or stored in firmware coupled to the processors. It should also be understood that these processors may have access to storage such as memory 555 or other storage devices or computer-readable media for storing instructions, data or both to assist in their operations. These instruction will cause these processors to operate in a manner substantially similar to the flow chart shown in FIG. 6. It should also be understood that these elements, as well as the A/D converter 520 may receive additional clock signals not described herewith.

Another variation for the systems shown in FIGS. 5 and 8 is the integration of various components into one component. For example, in FIGS. 5 and 8, processor 530, encoder 535, processor 540 and processor 550 may all be incorporated into one general purpose processor or ASIC. Similarly, the individual steps shown in FIG. 6 may be incorporated together into fewer steps or further divided out into sub-steps or some steps may be omitted. Finally, the organization of FIGS. 5 and 8 as well the order of the steps of FIG. 6 may be altered by one of ordinary skill in the art.

There are other alternatives in obtaining data used in determining to increase or decrease the frame rate. For example, the video system 800 shown in FIG. 8 includes automatic gain control signals 870 and 875. Instead of processor 550 determining to change the frame rate based upon comparing the luminance values of pixel data (as previously described), processor 550 may change the properties of the AGC signals 870 or 875 to change the frame rate. In this system, the AGC signals 870 and 875 will increase for decreasing light levels up to a point. Once that point is reached, the frame rate is adjusted and the AGC signals 870 or 875 can be decreased so as to increase the SNR as previously described. If the light level continues to decrease, the AGC signals 870 and 875 will again increase to a point. At this second point, the frame rate is reduced again and the AGC signals 870 and 875 are again increased. It follows that the reverse process occurs for increasing light conditions. It should also be noted that other automatic control signals such as automatic luminance control (ALC) and auto-shutter control (ASC) may be output by processor 550.

In yet another system, luminance values are averaged across multiple frames. In this system, the overall luminance values of a region or the entire frame are determined and compared for a plurality of frames instead of on a frame-by-frame basis.

The above systems and methods were described using threshold data and comparing that to a signal generated by the video processing system 500 or 800. The basis data could also instead by a correction curve or proportionality constant against which the data from the video processing system 500 or 800 is compared. Processor 550 compares the data output from a component of the system, A/D converter 525 for example, against the correction curve and generates the output control signal to clock circuit 545 based upon the proportionality of the A/D converter output data compared to the correction curve. In yet another system, processor 550 may input the data it receives from the video system, output of encoder 535 for example, into a function, which is the basis data, and use the result of the function to adjust the frame rate of the system via the control signal.

The above systems and methods have been described using a 1-to-1 correspondence between the frame rate and the first clock signal. Alternative relationships are also permissible. An example of such an alternative occurs in color imaging using a single image pick-up device. In this example, filer 515 also includes several color filters. For each desired color to be captured in the image, one color filter from filter 515 is placed between the lens 510 and image pick-up device 520 during the active phase of the vertical synchronization signal. In this exemplary system, the pulses shown in time lines (b), (c), (e) and (f) of FIG. 2 and time lines (h), (i), (k) and (l) would occur during the active phase of the vertical synchronization signal (i.e., between tₐ₀ and tₐ₁, t_{d0} and t_{d1}, t_{g0} and t_{g1}, and tⱼ₀ and tⱼ₁ and each set would be generated once for each color filter. This means that the onset of the pulses shown in timelines (b), (c), (e) and (f) and (h), (i), (k) and (l) need not wait until the vertical blanking period begins at times tₐ₁, t_{d1}, t_{g1} and tⱼ₁. Instead these pulses may be initiated at some proportion, say ⅓ for example, of either the entire vertical synchronization signal or the active phase of the vertical synchronization signal. It should also be noted that the clock signals supplied to image pick-up device 520 need not be related to a vertical blanking interval.

) The process shown in FIG. 6 may be implemented in a general, multi-purpose or single purpose processor. Such a processor will execute instructions, either at the assembly, compiled or machine-level, to perform that process. Those instructions can be written by one of ordinary skill in the art following the description of FIG. 6 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Finally, while the above systems and methods were described using full frame data, it should be understood that interleaved data may be captured and processed in like fashion.

1. A video device comprising:
an image pick-up device that captures image data and converts that image data into electrical signals wherein these electrical signals are transferred in response to a clock signal;
a clock circuit that generates the clock signal wherein a frequency of the clock signal is proportional to a frame rate and the clock circuit varies the frequency of the clock signal in response to a control signal; and
a first processor that receives first data and basis data and generates the control signal wherein the control signal is based upon a calculation using the first data and the basis data.

2. The video device of claim 1 further comprising:
an A/D converter coupled to the image pick-up device so as to receive the electrical signals from the image pick-up device and converts those electrical signals into second data wherein the first data is a sub-set of the second data.

3. The video device of claim 1 further comprising:
an A/D converter coupled to the image pick-up device so as to receive the electrical signals from the image pick-up device and converts those electrical signals into second data; and
a second processor coupled to the A/D converter so as to receive the second data from the A/D converter and manipulate the second data into third data wherein the first data is a sub-set of the third data.

4. The video device of claim 1 further comprising:
an A/D converter coupled to the image pick-up device so as to receive the electrical signals from the image pick-up device and converts those electrical signals into second data;
a second processor coupled to the A/D converter so as to receive the second data from the A/D converter and manipulate the second data into third data; and
an encoder coupled to the second processor so as to receive the third data from the second processor and encode the third data into fourth data wherein the first data is a sub-set of the fourth data.

5. The video device of claim 1 further comprising:
an A/D converter coupled to the image pick-up device so as to receive the electrical signals from the image pick-up device and converts those electrical signals into second data;
a second processor coupled to the A/D converter so as to receive the second data from the A/D converter and manipulate the second data into third data;
an encoder coupled to the second processor so as to receive the third data from the second processor and encode the third data into fourth data; and
a third processor coupled to the encoder so as to receive the fourth data from the encoder and manipulate the fourth data into fifth data wherein the first data is a sub-set of the fifth data.

6. The video device of claim 1 further wherein the basis data is threshold data and the device further comprises:
a switch coupled to the first processor that instructs the processor to retrieve the threshold data from one of a plurality of threshold data.

7. The video device of claim 1 further comprising:
a light sensor coupled to the first processor that measures a level of light and generates the first data based upon the measure of the level of light.

8. The video device of claim 3 wherein the sub-set of the third data includes all of the third data.

9. The video device of claim 1 wherein the basis data is correction curve and the calculation determines the proportionality between the first data and the correction curve.

10. The video device of claim 1 wherein the basis data is threshold data and the calculation is a comparison between the first data and the threshold data.

11. The video device of claim 5 wherein the first processor is coupled to the third processor so as to output a first control signal to the third processor wherein the third processor compensates for a select frame rate.

12. The video device of claim 11 wherein the third processor compensates for a select frame rate by creating new frames by copying existing frames.

13. The video device of claim 11 wherein the third processor compensates for a select frame rate by creating new frames by interpolating from existing frames.

14. The video device of claim 11 wherein the third processor compensates for a select frame rate by sending a control signal with the fifth data indicating the select frame rate.

15. The video device of claim 2 wherein the first processor is coupled to the A/D converter so as to output a second control signal to the A/D converter wherein the A/D converter changes its gain in response to the second control signal.

16. The video device of claim 3 wherein the first processor is coupled to the second processor so as to output a second control signal to the second processor wherein the second processor changes its gain in response to the second control signal.

17. The video device of claim 1 wherein the first data is used in the generation of an automatic control signal.

18. The video device of claim 3 wherein the sub-set of the third data includes data from a plurality of frames.

19. A computer-readable medium wherein the computer-readable medium comprises instructions for controlling a processor to perform a method comprising:
transferring first data generated by an image pick-up device at a clock rate proportional to a frame rate wherein the clock rate varies in response to a control signal issued by the processor;
generating second data from the first data;
comparing the second data to a threshold data so as to produce a resultant data; and
changing the control signal issued by the processor so as to adjust the clock rate in response to the resultant data.

20. The computer-readable medium of claim 19 wherein the instructions for generating second data further comprise averaging a value from a subset of the first data.

21. The computer-readable medium of claim 19 wherein the instructions for comparing the second data to the threshold data further comprise comparing a magnitude of the second data against a minimum threshold value.

22. The computer-readable medium of claim 21 wherein the instructions for changing the clock rate further comprises issuing the control signal so as to decrease the clock rate when the comparing determines that the magnitude of the second data is lower than the minimum threshold data.

23. The computer-readable medium of claim 19 wherein the instructions for comparing the second data to the threshold data further comprise comparing a magnitude of the second data against a maximum threshold value.

24. The method of claim 23 wherein the instructions for changing the clock rate further comprise increasing the clock rate when the comparing determines that the magnitude of the second data is higher than the maximum threshold data.
